(19) United States
(12) Patent Application Publication
(10) Pub. No.: US 2019/0205109 A1
(43) Pub. Date: Jul. 4, 2019

(54) COMPUTER SYSTEM, BASEBOARD MANAGEMENT CONTROLLER, AND OS INSTALLATION METHOD

(71) Applicant: NEC Corporation, Tokyo (JP)

(72) Inventor: Natnari SMITTHIMEDHIN, Tokyo (JP)

(73) Assignee: NEC Corporation, Tokyo (JP)

(21) Appl. No.: 16/232,191

(22) Filed: Dec. 26, 2018

(30) Foreign Application Priority Data
Dec. 28, 2017 (JP) 2017-253029

(51) Int. Cl. G06F 8/61; G06F 9/4401; G06F 11/30; G06F 11/34

(52) U.S. Cl. CPC G06F 8/61; G06F 9/4406; G06F 9/4416; G06F 11/3442; G06F 11/3006

(57) ABSTRACT

A server computer has a storage. A storage control unit of a baseboard management controller controls the storage of the server. An installation pack acquisition unit acquires an installation pack of an OS from an external server. An installation pack storing unit stores the installation pack of the OS into the storage of the server. A startup instruction unit starts up the server computer. The server computer executes, when it starts up, installation of the OS in accordance with the installation pack of the OS stored in the storage.

### CROSS REFERENCE TO RELATED APPLICATIONS

This application is based upon and claims the benefit of priority from Japanese patent application No. 2017-253029, filed on Dec. 28, 2017, the disclosure of which is incorporated herein in its entirety by reference.

### TECHNICAL FIELD

The present disclosure relates to a computer system and a baseboard management controller, in particular, relates to a baseboard management controller used for managing a server computer, and a computer system including a baseboard management controller of that kind.

Further, the present disclosure relates to an OS (Operating System) installation method in the above computer system.

### BACKGROUND

In recent years, as cloud services have been spreading and the data capacity handled in each service has been increasing, many large scale data centers having a huge number of servers have come to be seen. In the business operator handling a data center of this kind, man hours for the work required for constructing the server, in particular installing the OS in the server, tend to increase. Accordingly, a technique which facilitates the installation of the OS in the server, thereby reducing the man hours is demanded.

Regarding the installation of the OS in the server, a technique utilizing the PXE (Pre eXecution Environment) boot is known. The PXE boot is one of the boot environments of the computer, and it can perform operations such as OS installation, BIOS (Basic Input Output System) flush (a revisal of the BIOS ROM (Read Only Memory)), and BIOS setting changes by utilizing a network boot.

On the other hand, there are server computers in which a BMC (Baseboard Management Controller) is equipped with as functions for managing the server computer. A user can perform remote management such as monitoring and controlling of the hardware by communicating with the BMC via RMCP (Remote Management Control Protocol) using a remote PC (Personal Computer). Further, by using remote KVM (Keyboard, Video (Visual unit), Mouse), a user can install an OS via the network in the server computer using an installation medium on the remote PC

Regarding installation of the OS using the BMC, WO2016/067404A1 discloses OS installation in a blade server using the BMC. FIG. 7 shows a computer system disclosed in WO2016/067404A1. This computer system 500 includes a client PC 501, a SVP (SerVice Processor) 503, and one or more blade servers 504. The SVP 503 and the blade servers 504 are housed in a chassis 502.

The client PC 501 is a terminal by which a user performs an operation for installing the OS in the blade server 504. The SVP 503 is a computing unit for managing the chassis 502 and the blade servers 504. The SVP 503 has a memory device storing a SVP file system 531. An OS image 532 is arranged on the SVP file system 531. The OS image 532 is binary image data of an OS including prescribed device drivers.

The blade server 504 has a CPU 541 and a BMC 542. In the blade server 504, the CPU 541 and the BMC 542 are connected to each other via the USB (Universal Serial Bus). The BMC 542 has a function for emulating a USB device. The BMC 542 produces a virtual USB CD device 543 as a virtual CD (Compact Disk) drive for a main system executed on the CPU 541. An OS image 544 is inserted in the virtual USB CD device 543.

The user activates a Web browser on the client PC 501 and carries out an installation operation using an OS installation screen displayed on the Web browser. The BMC 542 detects the configurations of devices which the blade server 504 is equipped with, and transmits them to the SVP 503. The SVP 503 changes the OS image 532 so that it is compatible with the configuration information obtained from the BMC 542.

The BMC 542 mounts the SVP file system 531 on the system and emulates the SVP file system 531 as the virtual USB CD device 543. Then, the BMC 542 turns on the power of the blade server 504. After turning on the power, the blade server 504 boots a main system via the virtual USB CD device 543. The blade server 504 reads the OS image 544 changed so that it is compatible with the configuration information, inserted in the virtual USB CD device 543, and installs the OS in the blade server 504.

### SUMMARY

However, when the OS is installed utilizing the PXE boot, inevitably, an environment in which the PXE boot is possible must be constructed. In order to construct an environment in which the PXE boot is possible, servers for multiple protocols such as a BOOTP (Bootstrap Protocol)/DHCP (Dynamic Host Configuration Protocol) server, a PXE server, a TFTP (Trivial File Transfer Protocol) server, and an HTTP (Hypertext Transfer Protocol)/NFS (Network File System) server must be prepared and be set respectively. In the PXE boot, a PXE server must be prepared separately from a server computer to be installed, and thus there is a problem that it takes time to prepare and set the equipment.

When the PXE is utilized, it is conceivable to place the PXE server in a cloud and provide equipment, settings, and the like as services. In this case, it is possible to reduce the labor for constructing the PXE server. However, in the environment in which there is no PXE server when an OS is to be installed in a server, there is a problem that it is impossible to assign an IP address or connect to the internet.

On the other hand, in WO2016/067404A1, the SVP 503 and the BMC 542 are used for the installation of an OS. In WO2016/067404A1, the BMC 542 emulates the SVP file system 531 of the SVP 503 as a virtual device, and the blade server 504 installs the OS using the OS image inserted in the virtual device. However, in WO2016/067404A1, there is a problem that a relatively large capacity storage for storing the OS image is required in the SVP 503, apart from the storage of the blade server.

An example object of the present disclosure is to provide a computer system, a baseboard management controller, and an OS installation method capable of installing an OS in a server computer without requiring a relatively large capacity memory device in a baseboard management controller.

In order to accomplish the aforementioned object, the present disclosure provides a computer system comprising:

a server computer comprising a storage; and

a baseboard management controller,

wherein the baseboard management controller comprises:

a storage control unit configured to control the storage of the server computer;

an installation pack acquisition unit configured to acquire, when an OS (Operating System) is to be installed in the server computer, an installation pack of the OS from an external server;

an installation pack storing unit configured to store the installation pack into the storage of the server computer; and

a startup instruction unit configured to start up the server computer,

and wherein the server computer executes, when starting up, installation of the OS in accordance with the installation pack stored in the storage.

Further, the present disclosure provides a baseboard management controller comprising:

a monitoring unit configured to monitor a server computer having a storage;

a storage control unit configured to control the storage of the server computer;

an installation acquisition unit configured to acquire, when an OS is to be installed in the server computer, an installation pack of the OS from an external server;

an installation pack storing unit configured to store the installation pack into the storage of the server computer; and

a startup instruction unit configured to start up the server and cause the server to execute installation of the OS in accordance with the installation pack stored in the storage.

The present disclosure provides an OS (Operating System) installation method comprising:

acquiring, by a baseboard management controller configured to monitor a server computer having a storage, an installation pack of an OS from an external server;

storing, by the baseboard management controller, the installation pack into the storage of the server computer;

starting up, by the baseboard management controller, the sever computer to cause the server computer to execute installation of the OS in accordance with the installation pack stored in the storage.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF THE DRAWINGS

FIG. 1 is a block diagram showing a schematic configuration of a computer system according to the present disclosure.

FIG. 2 is a block diagram showing a computer system according to a first embodiment of the present disclosure.

FIG. 3 is a block diagram showing a configuration example of a baseboard management controller.

FIG. 4 is a block diagram showing a configuration example of a server computer.

FIG. 5 is a sequence chart showing an operation procedure when an OS is to be installed.

FIG. 6 is a block diagram showing a computer system according to a second embodiment of the present disclosure.

FIG. 7 is a block diagram showing a computer system disclosed in WO2016/067404A1.

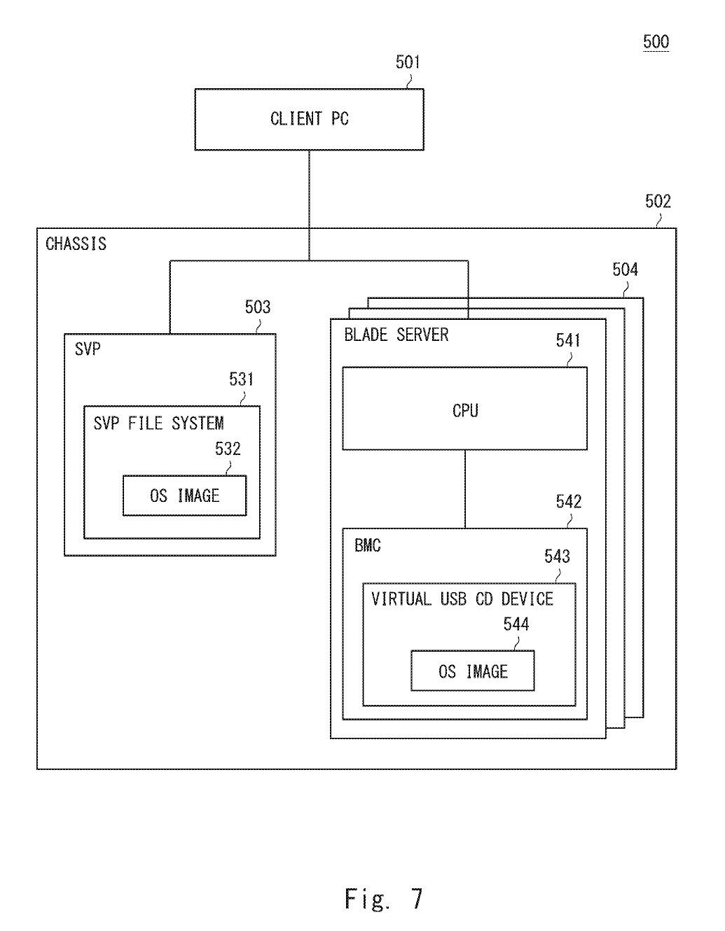

### EXEMPLARY EMBODIMENT

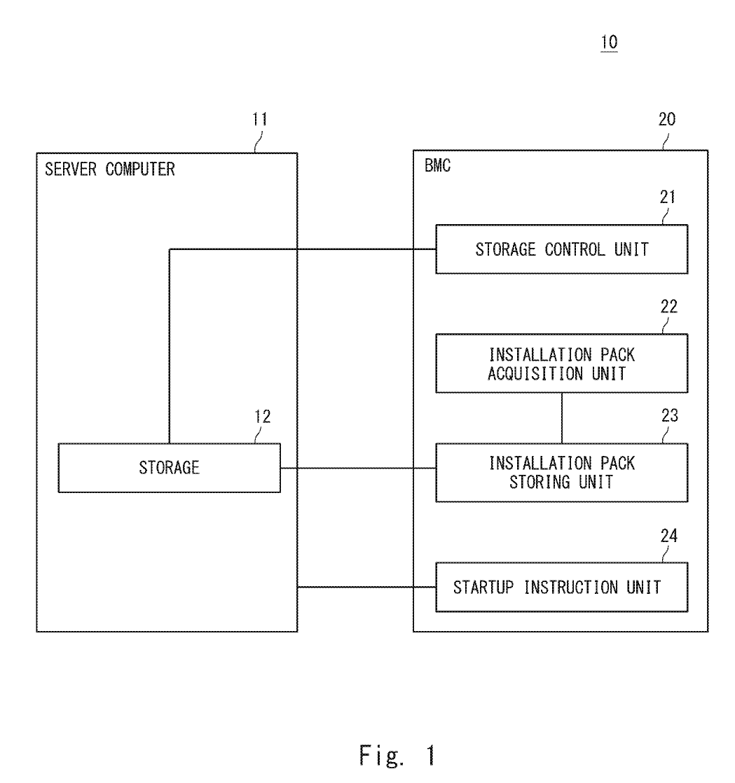

Prior to explain embodiments of the present disclosure, an outline of the present disclosure will be described. FIG. 1 shows a schematic configuration of a computer system according to the present disclosure. A computer system 10 includes a sever computer 11 and a baseboard management controller (BMC) 20. The server computer 11 has a storage 12. The baseboard management controller 20 has a storage control unit 21, an installation pack acquisition unit 22, an installation pack storing unit 23, and a startup instruction unit 24.

The storage control unit 21 controls the storage 12 of the server computer 11. The installation pack acquisition unit 22 acquires, when an OS is to be installed in the server computer 11, an installation pack from a not shown external server. The installation pack storing unit 23 stores the installation pack into the storage 12 of the server 11. The startup instruction unit 24 starts up the server computer 11. The server computer 11 executes, when starting up, installation of the OS in accordance with the installation pack stored in the storage 12.

In the computer system according to the present disclosure, the BMC 20 has the storage control unit 21. The installation pack storing unit 23 stores the acquired installation pack of the OS into the storage 12 of the server computer 11. The server computer 11 executes, when starting up, the installation of the OS in accordance with the installation pack stored in the storage 12. In this way, it is possible to install the OS in the server computer 11 without using a PXE boot function or the like.

Further, in the computer system according to the present disclosure, the BMC 20 stores the installation pack of the OS into the storage 12 of the server computer 11 in which the OS is to be installed. By doing so, it is possible to install the OS in the server computer 11 without requiring a relatively large capacity memory device in the BMC 20.

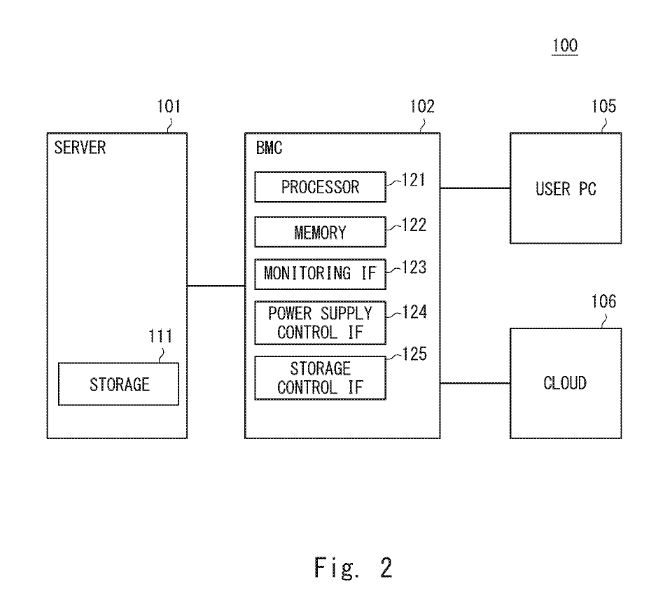

Hereinafter, embodiments of the present disclosure will be described in detail with reference to the accompanying drawings. FIG. 2 shows a computer system according to a first embodiment of the present disclosure. A compute system 100 according to the present embodiment has a server computer 101 and a baseboard management controller (BMC) 102. The BMC 102 is arranged corresponding to the server computer 101. BMC 102 may be mounted on the sever computer 101. The server computer 101 corresponds to the server computer 11 shown in FIG. 1, and the BMC 102 corresponds to the BMC 20 shown in FIG. 1.

The BMC 102 is configured to be capable of connecting to a user PC 105 via any type of a network including a LAN (Local Area Network) or a WAN (Wide Area Network). Further, the BMC 102 is configured to be capable of connecting to a cloud 106 via any type of a network.

The server computer 101 is configured as a computing device. The server computer 101 includes a storage 111. The storage 111 is configured as, for example, an auxiliary storage device such as a hard disk drive or an SSD (Solid State Drive). In the storage 111, various program files or data are stored. The storage 111 is a boot drive of the server computer 101 and an OS is installed therein. The storage 111 corresponds to the storage 12 shown in FIG. 1.

The BMC 102 includes a processor 121, a memory 122, a monitoring IF (interface) 123, a power supply control IF 124, and a storage control IF 125. The processor 121 reads out a program stored in the memory 122 and executes various processes such as monitoring and controlling of the server computer 101. The monitoring IF 123 is an interface used for monitoring/controlling or the like of the server computer 101. The power supply control IF 124 is an interface used for power supply controlling or the like of the server computer 101. The storage control IF 125 is an interface for controlling of the storage 111 of the server computer 101.

The user PC 105 is, for example, a general purpose computing device used by a user. The user can access the BMC 102 using the user PC 105 and carry out various controls and the like. The cloud 106 is a cloud server (external server) placed in a cloud environment. The cloud 106 holds an installation pack of the OS to be installed in the server computer 101. When transmission of the installation pack of the OS is requested from the BMC 102, the cloud 106 provides the installation pack of the OS requested.

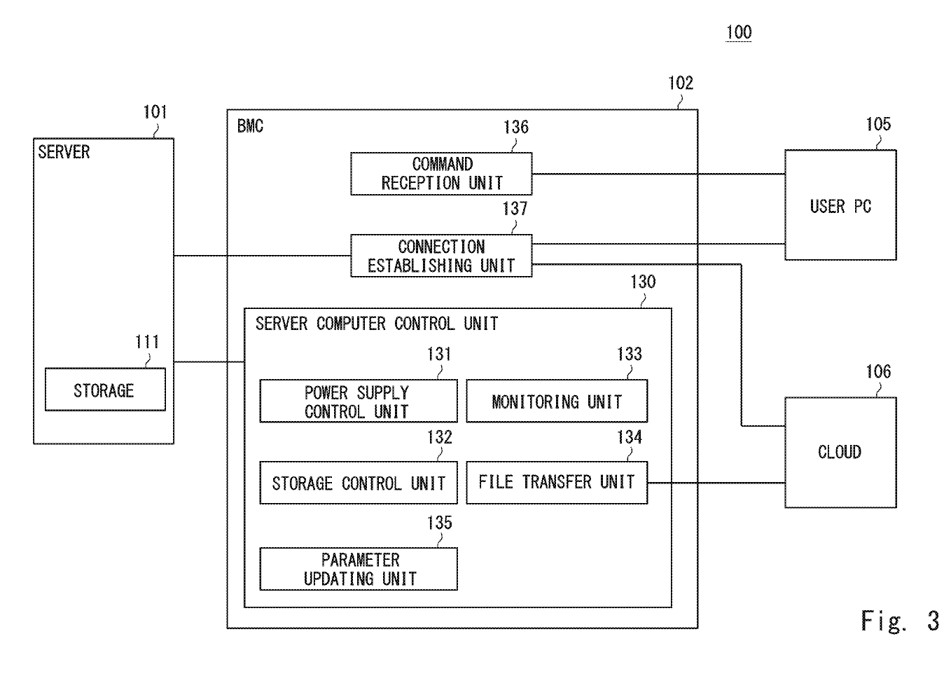

FIG. 3 shows a configuration example of the BMC 102. The BMC 102 includes a server computer control unit 130, a command reception unit 136, and a connection establishing unit 137. The server computer control unit 130 includes a power supply control unit 131, a storage control unit 132, a monitoring unit 133, a file transfer unit 134, and a parameter updating unit 135. In the BMC 102, at least a portion of the functions of the power supply control unit 131, the storage control unit 132, the monitoring unit 133, the file transfer unit 134, the parameter updating unit 135, the command reception unit 136, and the connection establishing unit 137 may be realized by the processor 121 (refer to FIG. 2) operating in accordance with the program read out from the memory 122.

The connection establishing unit 137 establishes the connection between the BMC 102 and an external device or the like. The connection establishing unit 137 establishes the connection between the server computer 101 and the BMC 102. Further, the connection establishing unit 137 establishes the connection between the user PC 105 and the cloud 106 and the BMC 102, respectively. The command reception unit 136 receives various commands and the like from the user PC 105 with which the connection establishing unit 137 has established the connection. The BMC 102 operates in accordance with the command received by the command reception unit 136.

The power supply control unit 131 controls the power supply of the server computer 101. The power supply control unit 131 carries out the power supply control of the server computer 101, for example, via the power supply control IF 124 (refer to FIG. 2) to control startup, stop, and the like of the server computer 101. The power supply control unit 131 functions as the startup instruction unit 24 shown in FIG. 1.

The storage control unit 132 controls the storage 111 of the server computer 101. The storage control unit 132 accesses the storage 111 via the storage control IF 125, and writes data to the storage 111. The storage control unit 132 corresponds to the storage control unit 21 shown in FIG. 1.

The monitoring unit 133 monitors the sever computer 101. The monitoring unit 133 acquires, for example, event logs and hardware information of the server computer 101 via the monitoring IF 123. Further, the monitoring unit 133 detects the occurrence of a failure in the server computer 101 through the monitoring IF 123.

The file transfer unit 134 receives a file from an external device and transfers the received file to another external device. The file transfer unit 134 receives the installation pack of the OS from the cloud 106 and transfers the received installation pack to the storage 111 of the server computer 101. The file transfer unit 134 functions as the installation pack acquisition unit 22 and the installation pack storing unit 23 shown in FIG. 1.

The parameter updating unit 135 acquires a parameter file and updates installation parameters of the installation pack of the OS stored in the storage 111 of the server computer 101 in accordance with the acquired parameter file. The parameter file includes necessary setting information such as basic information and network information in the installation of the OS. The parameter file is a text file in which setting information was edited beforehand. For example, the parameter file is created by a user and stored in not-shown memory device in the BMC 102. Alternatively, the parameter file may be registered in the cloud 106 or may be stored in the storage 111 beforehand.

The parameter updating unit 135 updates, before installation of the OS is carried out in the server computer 101, environment dependent parameters on the server computer 101 in accordance with the parameter file. The parameter updating unit 135 reads out information included in the parameter file one by one and updates the installation parameters, so that the server computer 101 can automatically proceed with setting up the OS. In this way, when the OS is to be installed, it is possible to construct the individual environment of the server computer 101.

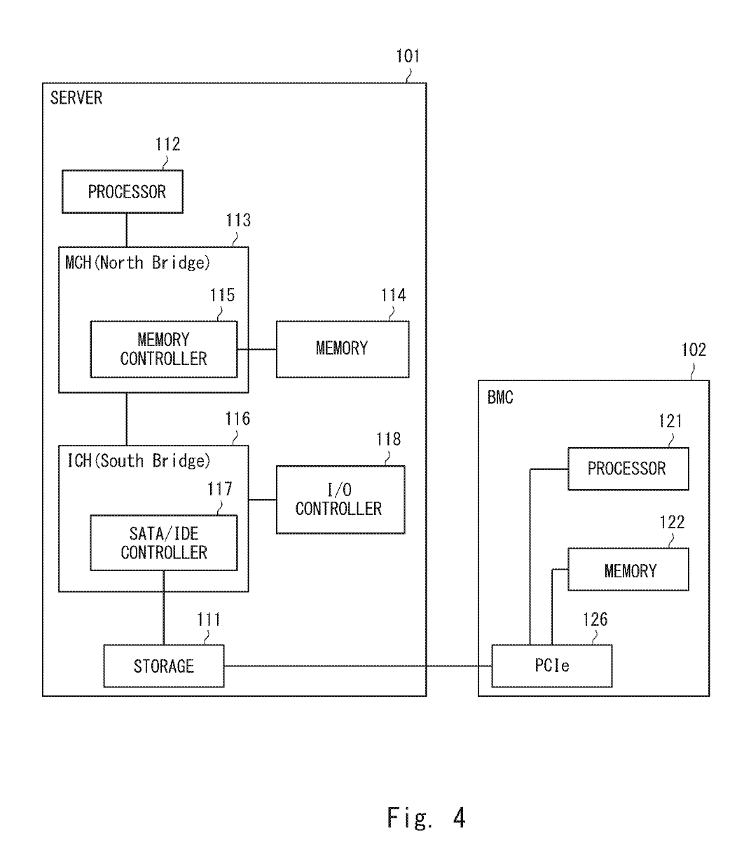

FIG. 4 shows a configuration example of the server computer 101. The server computer 101 includes the storage 111, a processor 112, an MCH (Memory Controller Hub) 113, a memory 114, an ICH (I/O Controller Hub) 116, and an I/O controller 118. The processer 112 carries out various processes including startup of the OS and installation of the OS in the server computer 101.

The MCH 113 includes a memory controller 115 and carries out access control to the memory 114. The ICH 116 includes an SATA (Serial ATA (Advanced Technology Attachment))/IDE (Integrated device electronics) controller (storage controller) 117, and controls the storage 111. The MCH 113 also operates as a bridge connecting between the processor 112 and the ICH 116.

The processor 121 (storage control unit 132) of the BMC 102 communicates with the storage 111 of the server computer 101 through a PCIe (Peripheral Component Interconnect Express) 126. When the power supply to the server computer 101 is shut down, the BMC 102 obtains the control right to the storage 111 and thus it is able to access the storage 111. When the server computer 101 is powered on, the control right to the storage 111 is switched to the SATA/IDE controller 117 of the server computer 101. The BMC 102 can obtain the control right at any timing after the server computer 101 is powered on. When the BMC 102 obtains the control right, the SATA/IDE controller 117 cannot access the storage 111.

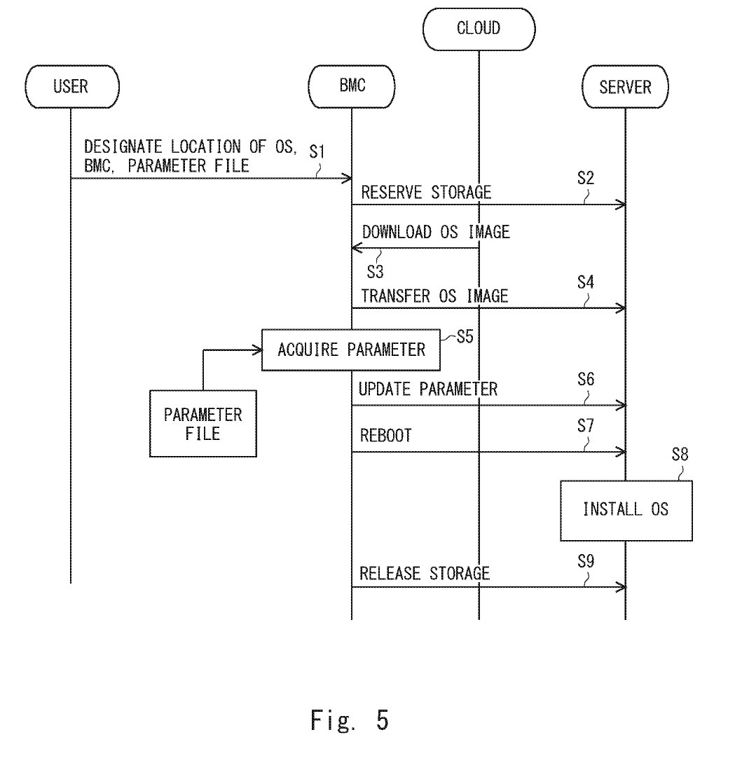

FIG. 5 shows an operation procedure when an OS is to be installed. The installation of the OS is carried out in a state, for example, in which the power does not supply to the server computer 101. The user connects the user PC 105 to the BMC 102 corresponding to the server computer 101 in which the OS is to be installed. The user designates the OS to be installed, the BMC 102, and the location of the parameter file (Step S1). The user PC 105 sends, for example, a command for installing the OS, information designating the OS to be installed, and the like at Step S1.

The storage control unit 132 of the BMC 102 accesses the storage 111 of the server computer 101 on which the BMC 102 is mounted and reserves the storage 111 (Step S2). As the BMC 102 reserves the storage 111, the control right to the storage 111 is moved to the BMC 102, and thus the server computer 101 cannot access the storage 111.

The file transfer unit 134 of the BMC 102 accesses the cloud 106 and downloads an installation pack (OS image) of the OS designated at Step S1 from the cloud 106 (Step S3). The file transfer unit 134 transfers the downloaded OS image to the storage 111 of the server computer 101 (Step S4). The file transfer unit 134 carries out data transfer to the storage 111 via the storage control unit 132 at Step S4, and transfers the OS image to the storage 111 and stores it therein.

The parameter updating unit 135 acquires the parameter file (Step S5). The parameter updating unit 135 acquires, at Step S5, the parameter file, for example, from the location designated at Step S1. The parameter updating unit 135 may acquire the parameter file directly from the user PC 105 at Step S1. The parameter updating unit 135 updates environment dependent parameters in the OS image stored in the storage 111 using the acquired parameter file (Step S6). The parameter updating unit 135 accesses the storage 111 via the storage control unit 132 at Step S6. The parameter updating unit 135 updates environment dependent parameters among the parameters included in the OS image in order to adapt the individual environment.

The power supply control unit 131 causes the server computer 101 to reboot, after the parameters are updated (Step S7). The server computer 101 reboots using the OS image stored in the storage 111, which is a boot drive, and installs the OS in accordance with the OS image and contents of the updated installation parameters (Step S8). At this time, the control right of the storage 111 is owned by the SATA/IDE controller 117 of the server computer 101.

The storage control unit 132 of the BMC 102 releases the storage 111 at a user desired timing after the OS is installed therein (Step S9). The storage control unit 132 generates, at Step S9, an address and a control signal via PCIe 126 (refer to FIG. 4) in the similar way to the data writing, and releases the storage 111.

In the present embodiment, the BMC 102 acquires, from the cloud 106, the installation pack (OS image) for installing the OS. In the present embodiment, unlike the case in which the PXE boot is utilized, it is not necessary to construct a server for installation. Further, it is not necessary to preliminarily prepare the OS image file and the like on the user PC 105. In the present embodiment, the cloud 106 is utilized for acquiring the OS image file, whereby it is possible to reduce resources, time, and power consumption necessary for constructing a server for installation.

In the present embodiment, the BMC 102 includes the storage control unit 132, and the BMC 102 is able to access the storage 111 of the server computer 101. The BMC 102 stores the OS image downloaded from the cloud 106 in the storage 111 of the server computer 101. In this case, the BMC 102 may not include a relatively large-scale storage device for storing the OS image downloaded from the cloud 106. Accordingly, in the present embodiment, the circuit scale can be reduced comparing to the computer system disclosed in WO2016/067404A1 in which the BMC mounts the file system of the SVP.

In the present embodiment, the BMC 102 stores the OS image in the storage device 111 of the server computer 101, and causes the server computer 101 to reboot after the installation parameters are updated. The server computer 101 carries out the installation of the OS in accordance with the OS image stored in its own storage 111. In the present embodiment, the installation of the OS is carried out autonomously in the rebooted server computer 101. For this reason, the present embodiment has an advantage that the user PC 105 is not necessarily kept to be connected to the BMC 105 or the server computer 101 during the installation of the OS.

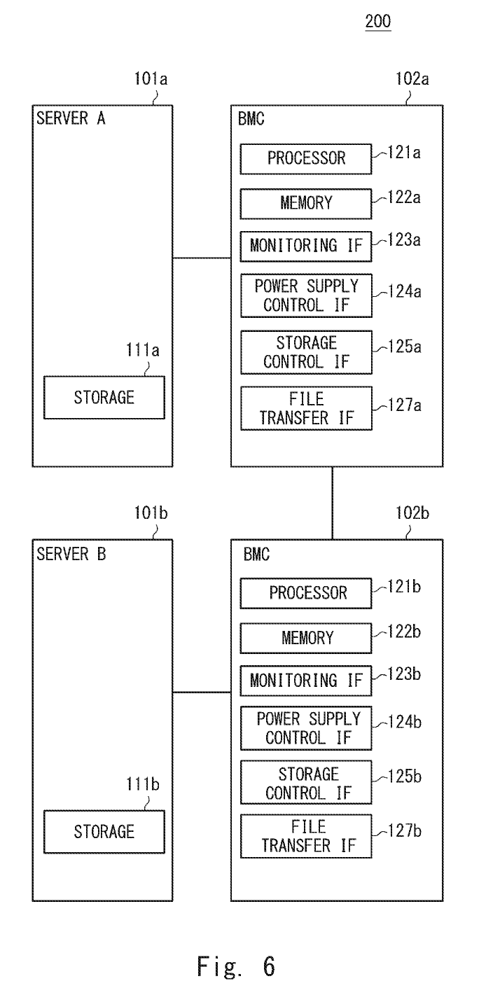

Next, a second embodiment of the present disclosure will be explained. FIG. 6 shows a computer system according to a second embodiment of the present disclosure. A computer system 200 includes a server computer (server A) 101a, a server computer (server B) 101b, a BMC 102a, and a BMC 102b. The BMC 102a is, for example, mounted on the server A 101a. The BMC 102b is, for example, mounted on the server B 101b.

The BMC 102a includes, in addition to the components shown in FIG. 2, a file transfer IF (communication interface) 127a. The BMC 102b includes, in addition to components shown in FIG. 2, a file transfer IF 127b. The file transfer IF 127a is an interface for the BMC 102 to communicate with other BMCs. The file transfer IF 127b is an interface for the BMC 102b to communicate with other BMCs. The BMC 102a and the BMC 102b can communicate with each other via the file transfer IF 127a and 127b.

In the present embodiment, the file transfer unit 134 (refer to FIG. 3) of the BMC 102a corresponding to the server A can transfer the OS image to other BMCs via the file transfer IF 127a. In addition, the file transfer unit 134 of the BMC 102a can acquire the OS image from other BMCs via the file transfer IF 127a. Similarly, the file transfer unit 134 of the BMC 102b corresponding to the server B can transfer the OS image to other BMCs via the file transfer IF 127b. Further, the file transfer unit 134 of the BMC 102b can acquire the OS image from other BMCs via the file transfer IF 127b.

For example, a case where no OS is installed in the storage 111b of the serve B 102b is considered. It is assumed that the power supply to the server B 102b is shutdown. The storage control unit 132 (refer to FIG. 3) of the server B 102b reserves the storage 111b of the server B 101b. The file transfer unit 134 of the BMC 102a corresponding to the server A acquires the OS image from the storage 111a of the server A 101a. The file transfer unit 134 of the BMC 102a transfers the OS image to the BMC 102b corresponding to the server B via the file transfer IF 127a.

The file transfer unit 134 of the BMC 102b corresponding to the server B acquires the OS image transferred from the BMC 102a via file transfer IF 127b. The file transfer unit 134 stores the OS image in the storage 111b of the server B 101b. If the parameter file is designated, the parameter updating unit 135 updates installation parameters in the OS image in accordance with the designated parameter file. The power supply control unit 131 turns on the power to the server B 101b and causes the server B 101b to startup. The server B 102b carries out the startup using the OS image stored in the storage 111b, which is a boot drive, and installs the OS in accordance with the OS image and contents of the updated installation parameters.

In the present embodiment, the BMC 102a and 102b include the file transfer IF 127a and 127b, and it is possible to transfer a file between the BMCs of the multiple servers. In the present embodiment, for example, an OS image stored in the storage of a server computer can be transferred to another server computer, and thus it is possible to copy or move the OS. Further, in the present embodiment, by using the file transferring function between the BMCs, it is possible to distribute the OS image acquired from the cloud 106 (refer to FIG. 2) to multiple server computers and to install the OS thereto.

According to the embodiments of the computer system, the baseboard management controller, and the OS installation method, it is possible to install the OS in the server computer without requiring a relatively large capacity memory device in the baseboard management controller.

It should be noted that, in the each of the above embodiments, a program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described embodiments and can be modified as appropriate without departing from the spirit and scope of the present disclosure. Further, the present disclosure may be implemented by combining the above-described embodiments with one another.

While the present disclosure has been particularly shown and described with reference to embodiments thereof, the present disclosure is not limited to these embodiments. It will be understood by those of ordinary skill in the art that various changes in form and details may be made therein without departing from the spirit and scope of the present disclosure as defined by the claims.

For example, the whole or part of the exemplary embodiments disclosed above can be described as, but not limited to, the following supplementary notes.

### [Supplemental Note 1]

A computer system comprising:

a server computer comprising a storage; and

a baseboard management controller,

wherein the baseboard management controller comprises:

a storage control unit configured to control the storage of the server computer;

an installation pack acquisition unit configured to acquire, when an OS (Operating System) is to be installed in the server computer, an installation pack of the OS from an external server;

an installation pack storing unit configured to store the installation pack into the storage of the server computer; and

a startup instruction unit configured to start up the server computer,

and wherein the server computer executes, when starting up, installation of the OS in accordance with the installation pack stored in the storage.

### [Supplemental Note 2]

The computer system according to Supplemental Note 1, wherein:

the installation pack includes installation parameters; and

the baseboard management controller further comprises a parameter updating unit configured to update the installation parameters in accordance with a parameter file.

### [Supplemental Note 3]

The computer system according to Supplemental Note 1 or 2, wherein:

the server computer further comprises a storage controller configured to control the storage; and

the storage control unit of the baseboard management controller and the storage controller of the server exclusively obtain a control right of the storage.

### [Supplemental Note 4]

The computer system according to Supplemental Note 3, wherein the storage controller of the server computer owns the control right when the server computer starts up.

### [Supplemental Note 5]

The computer system according to any one of Supplemental Notes 1 to 4, wherein the baseboard management controller further comprises a command reception unit configured to receive, from a user terminal, a command for installing the OS in the server computer.

### [Supplemental Note 6]

The computer system according to Supplemental Note 5, wherein the installation pack acquisition unit accesses an external server holding the installation pack of the OS designated by the command to acquire the installation pack from the external server.

### [Supplemental Note 7]

The computer system according to any one of Supplemental Notes 1 to 6, wherein:

the baseboard management controller further comprises a communication interface configured to communicate with other baseboard management board; and

the installation pack acquisition unit acquires the installation pack from the other baseboard management controller via the communication interface.

### [Supplemental Note 8]

The computer system according to any one of Supplemental Notes 1 to 7, wherein the baseboard management controller further comprises a monitoring unit configure to monitor the server computer.

### [Supplemental Note 9]

The computer system according to any one of Supplemental Notes 1 to 8, wherein the storage of the server computer is a boot drive of the server computer.

### [Supplemental Note 10]

The computer system according to any one of Supplemental Notes 1 to 9, wherein the external server is a cloud server provided in a cloud.

### [Supplemental Note 11]

A baseboard management controller comprising:

a monitoring unit configured to monitor a server computer having a storage;

a storage control unit configured to control the storage of the server computer;

an installation acquisition unit configured to acquire, when an OS is to be installed in the server computer, an installation pack of the OS from an external server;

an installation pack storing unit configured to store the installation pack into the storage of the server computer; and

a startup instruction unit configured to start up the server and cause the server to execute installation of the OS in accordance with the installation pack stored in the storage.

### [Supplemental Note 12]

The baseboard management controller according to Supplemental Note 11, wherein the installation pack includes installation parameters, and

the baseboard management controller further comprises a parameter updating unit configured to update the installation parameters in accordance with a parameter file.

### [Supplemental Note 13]

An OS (Operating System) installation method comprising:

acquiring, by a baseboard management controller configured to monitor a server computer having a storage, an installation pack of an OS from an external server;

storing, by the baseboard management controller, the installation pack into the storage of the server computer;

starting up, by the baseboard management controller, the sever computer to cause the server computer to execute installation of the OS in accordance with the installation pack stored in the storage.

### [Supplemental Note 14]

The OS installation method according to Supplemental Note 13,

wherein the installation pack includes installation parameters; and

the OS installation method further comprises updating, by the baseboard management controller, the installation parameters in accordance with a parameter file.

### [Supplemental Note 15]

A non-transitory computer readable medium storing a program for causing a baseboard management controller configured to monitor a server computer having a storage to execute:

acquiring an installation pack of an OS from an external server;

storing the installation pack into the storage of the server computer;

starting up the sever computer to cause the server computer to execute installation of the OS in accordance with the installation pack stored in the storage.

### [Supplemental Note 16]

The non-transitory computer readable medium according to Supplemental Note 15,

wherein the installation pack includes installation parameters; and

the program further causes the baseboard management controller to execute updating the installation parameters in accordance with a parameter file.

What is claimed is:

1. A computer system comprising:
a server computer comprising a storage; and
a baseboard management controller,
wherein the baseboard management controller comprises:
a storage control unit configured to control the storage of the server computer;
an installation pack acquisition unit configured to acquire, when an OS (Operating System) is to be installed in the server computer, an installation pack of the OS from an external server;
an installation pack storing unit configured to store the installation pack into the storage of the server computer; and
a startup instruction unit configured to start up the server computer,
and wherein the server computer executes, when starting up, installation of the OS in accordance with the installation pack stored in the storage.

2. The computer system according to claim 1, wherein:
the installation pack includes installation parameters; and
the baseboard management controller further comprises a parameter updating unit configured to update the installation parameters in accordance with a parameter file.

3. The computer system according to claim 1, wherein:
the server computer further comprises a storage controller configured to control the storage; and
the storage control unit of the baseboard management controller and the storage controller of the server exclusively obtain a control right of the storage.

4. The computer system according to claim 3, wherein the storage controller of the server computer owns the control right when the server computer starts up.

5. The computer system according to claim 1, wherein the baseboard management controller further comprises a command reception unit configured to receive, from a user terminal, a command for installing the OS in the server computer

6. The computer system according to claim 5, wherein the installation pack acquisition unit accesses an external server holding the installation pack of the OS designated by the command to acquire the installation pack from the external server.

7. The computer system according to claim 1, wherein:
the baseboard management controller further comprises a communication interface configured to communicate with another baseboard management board; and
the installation pack acquisition unit acquires the installation pack from the other baseboard management controller via the communication interface.

8. The computer system according to claim 1, wherein the baseboard management controller further comprises a monitoring unit configured to monitor the server computer.

9. The computer system according to claim 1, wherein the storage of the server computer is a boot drive of the server computer.

10. The computer system according to claim 1, wherein the external server is a cloud server provided in a cloud.

11. A baseboard management controller comprising:
a monitoring unit configured to monitor a server computer having a storage;
a storage control unit configured to control the storage of the server computer;
an installation acquisition unit configured to acquire, when an OS is to be installed in the server computer, an installation pack of the OS from an external server;
an installation pack storing unit configured to store the installation pack into the storage of the server computer; and
a startup instruction unit configured to start up the server and cause the server to execute installation of the OS in accordance with the installation pack stored in the storage.

12. The baseboard management controller according to claim 11, wherein the installation pack includes installation parameters, and
the baseboard management controller further comprises a parameter updating unit configured to update the installation parameters in accordance with a parameter file.

13. An OS (Operating System) installation method comprising:
acquiring, by a baseboard management controller configured to monitor a server computer having a storage, an installation pack of an OS from an external server;
storing, by the baseboard management controller, the installation pack into the storage of the server computer;
starting up, by the baseboard management controller, the sever computer to cause the server computer to execute installation of the OS in accordance with the installation pack stored in the storage.

14. The OS installation method according to claim 13,
wherein the installation pack includes installation parameters; and
the OS installation method further comprises updating, by the baseboard management controller, the installation parameters in accordance with a parameter file.
